(19) United States
(12) Patent Application Publication
(10) Pub. No.: US 2008/0233473 A1
(43) Pub. Date: Sep. 25, 2008

(54) MEMBRANE AND METHOD FOR MAKING THE SAME

(75) Inventors: YUAN-PENG LI, Beijing (CN); CHANG-HONG LIU, Beijing (CN); SHOU-SHAN FAN, Beijing (CN)

Correspondence Address: PCE INDUSTRY, INC.;ATT. CHENG-JU CHIANG, 458 E. LAMBERT ROAD, FULLERTON, CA, 92835, US

(73) Assignees: TSINGHUA UNIVERSITY, Beijing (CN); HON HAI PRECISION INDUSTRY CO., LTD., Tu-Cheng (TW)

(21) Appl. No.: 11/947,068

(22) Filed: Nov. 29, 2007

(30) Foreign Application Priority Data
Mar. 23, 2007 (CN) 200710073651.3

(51) Int. Cl. H01M 2/14; B29C 43/20; B29C 45/00

(52) U.S. Cl. 429/129; 264/257; 427/58

(57) ABSTRACT

A membrane includes a fiber material (e.g., in fabric form) and an agar material distributed so as to surround the fiber material. Another membrane includes an agar material and a fiber material (e.g., non-woven fibers) dispersed in the agar. Moreover, a method for making the membrane includes the steps of: (a) mixing the agar material with water to form a slurry of agar; (b) immerging a fiber material into the slurry of agar to form a pre-composite; (c) molding the pre-composite to form a composite and solidifying the composite to obtain the membrane.

### RELATED APPLICATIONS

This application is related to a commonly-assigned application entitled, “ELECTRICAL ENERGY STORAGE SYSTEM”, filed ______ (Atty. Docket No. US14151). Disclosure of the above-identified application is incorporated herein by reference.

### BACKGROUND

1. Field of the Invention

The invention relates to membranes and methods for making the same and, particularly, to a membrane used in a capacitor or a battery system and a method for making the same.

2. Discussion of Related Art

A membrane is an important component used in a capacitor or a battery system. In order to avoid a short connection of an anode and a cathode, the membrane can, opportunely, be used to separate active materials between the anode and the cathode.

In the charge-discharge process of the battery, ions in the electrolyte migrate. That is, in the charge process, ions penetrate the membrane from the side of the cathode to the side of the anode, thereby inserting into the anode. In the discharge process, the ions extract/take of from the anode, and return from the side of the anode to the side of cathode. In the process of the ions migrating from the membrane, the battery storages and releases the electrical energy. Thus, the membrane existed in the anode and the cathode plays an important role as ion channels. The membrane commonly used in the battery, is constituted of at least one substance selected from the group of a polyolefin non-woven fabric, a PVC microporous membrane, a hard rubber microporous membrane, and a glass fiber membrane. However, the membrane made of the foregoing materials, commonly, has its own shortcomings, such as a complicated production process, a high cost of production, a poor lyophilic behavior with respect to liquid, a poor electrolyte saturation level, a less than optimum chemical stability, a tendency to corrode fairly easily, and/or a poor oxidation resistance, etc.

What is needed, therefore, is a low-cost, chemically durable membrane capable of being saturated with the electrolyte.

### SUMMARY

A membrane, according to a first embodiment, includes an agar and a fiber material. The agar is distributed in a manner so as to surround the fiber material, and/or the agar is formed/deposited on the surface of fibers and in the gaps between the fibers.

Another membrane, according to a second embodiment, includes an agar and a fiber material. The fiber material is dispersed in the agar, and/or the fiber material is uniformly distributed within the agar.

A method for making the foregoing membrane includes the steps of: (a) mixing an agar with water to form a slurry of agar; (b) immerging a fiber material into the slurry of agar to form a pre-composite; and (c) molding the pre-composite to form a composite and solidifying the composite to obtain the membrane.

Other advantages and novel features of the present membrane and method for making the same will become more apparent from the following detailed description of preferred embodiments, when taken in conjunction with the accompanying drawings.

### BRIEF DESCRIPTION OF THE DRAWINGS

Many aspects of the present membrane can be better understood with reference to the following drawings. The components in the drawings are not necessarily to scale, the emphasis instead being placed upon clearly illustrating the principles of the present membrane.

FIG. 1 is a schematic diagram of a compounding device to form a pre-composite containing the slurry of the agar and the fabric of fibers, in accordance with a present embodiment; and

FIG. 2 is a schematic diagram of a squeezing/compression device to squeeze a pre-composite to obtain the membrane, in accordance with the present embodiment.

Corresponding reference characters indicate corresponding parts throughout the several views. The exemplifications set out herein illustrate at least one present embodiment of the membrane and the method for making the same, in at least one form, and such exemplifications are not to be construed as limiting the scope of the invention in any manner.

### DETAILED DESCRIPTION OF PREFERRED EMBODIMENTS

Reference will now be made to the drawings to describe, in detail, embodiments of the present membrane.

The present invention provides two types of membranes. A first type membrane includes an agar (i.e., a natural polysaccharide polymer material) and a fabric material. Agar materials can, for example, can be derived from certain algae. The agar is distributed so as to surround the fibers of the fabric material. A second type membrane includes an agar and a non-woven fiber material. The non-woven fiber material is dispersed in the agar.

The first type membrane is constituted of a fabric of fibers. The fabric of fibers includes at least one of natural fibers and artificial fibers, in the form of, e.g., a gauze fabric, a non-woven fabric, a cotton fabric, and/or a glass fiber film/fabric. In the first type membrane, the agar is formed/deposited on the surface of fibers of the fabric and in the gaps between the fibers.

The second type membrane is constituted of non-woven fibers. The non-woven fibers include at least one substance selected from paper pulp and wood pulp. In the second type membrane, the fiber material is uniformly distributed and bonded with the agar. That is, the non-woven fiber material is dispersed in the agar.

A method for making the foregoing membrane includes the following steps: (a) mixing an agar with water to form a slurry of agar; (b) immerging/dropping a fiber material into the slurry of agar to form a pre-composite; and (c) molding the pre-composite to form a composite and solidifying the composite to obtain the membrane.

Reference will now be made, in detail, to the method for making the membrane.

In the first present embodiment, the fabric of fibers and the agar are selected as raw materials to make the membrane.

The step (a) further includes the steps of: (a1) mixing the agar with water at room temperature for about 8-10 hours to form an agar-water dispersion system; and (a2) heating and agitating the agar-water dispersion system in a water bath at a temperature of about 80˜95° C., for about 2-3 hours to form a slurry of agar.

In step (a1), in the agar-water dispersion system, a quality percentage of the agar is in the approximate range from 1% to 2%. In the process of absorbing water, the agar gradually reaches a soft, swelled, and transparent state. When the agar is nearly completely dissolved/dispersed in the water, a transparent slurry of agar is obtained. In step (a2), to avoid the transparent slurry of agar from solidifying and/or the agar separating therefrom, a continuous heating at about 80˜95° C. in the water bath is maintained.

The step (b) further includes the steps of: (b1) providing at least one fabric of fibers and immersing each fabric into the slurry of agar to form a pre-composite; and (b2) heating and agitating the pre-composite in the water bath at the temperature of about 80˜95° C.

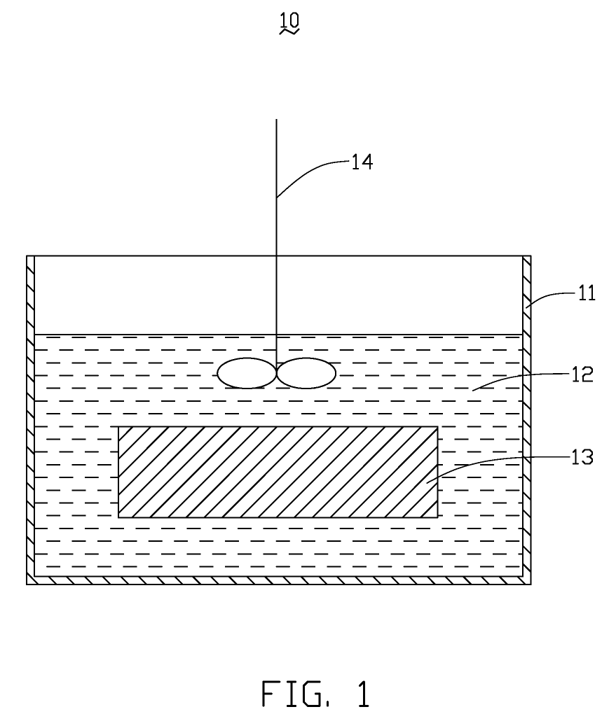

Referring to FIG. 1, a compositing device 10 is provided to form a pre-composite containing the slurry of agar 12 and the fabric of fibers 13. The compositing device 10 includes a container 11 and a stirrer 14.

In step (b1), the fabric of fibers 13, like a gauze fabric, is cut or otherwise formed to a predetermined size/shape. The cut gauze fabric 13 is immersed into the slurry of agar 12 within the container 11 to form a pre-composite. In step (b2), the container 11 with the pre-composite therein is put into the water bath to heat. To avoid the slurry of agar 12 solidifying, the stirrer 14 is used to agitate the slurry of agar 12 for about 2-3 minutes during the process of heating, during which time a continuous heating of the water bath is also needed. The agitating can make the slurry of agar 12 deposit effectively on and within the cut gauze fabric 13. That is, agar 12 from the slurry thereof is thereby able to fully form/deposit on the surface of fibers and in the gaps between the fibers. Furthermore, the agitating process can also remove bubbles in the slurry of agar 12 to make the slurry of agar 12 with the cut gauze fabric 13 bond/attach well therewith, thus transforming from a pre-composite form to a composite form.

Step (c) further includes the steps of: (c1) spreading out (i.e., placing) the composite between two spacers; (c2) squeezing/compressing the pre-composite using the two spacers, under a certain pressure, to yield a composite; and (c3) cooling and solidifying the composite, and removing the two spacers to obtain the membrane.

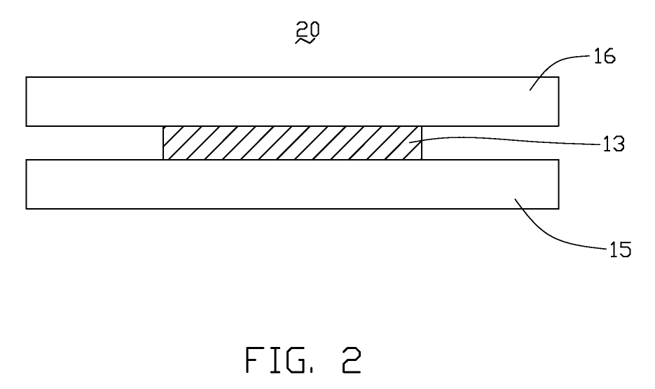

Referring to FIG. 2, a squeezing/compressing device 20 is provided to squeeze the pre-composite to form the membrane. The squeezing device 20 includes a first spacer 15 and a second spacer 16.

In step (c1), the pre-composite is taken out from the container 11 and smoothly spread out on the surface between two spacers. Specifically, the pre-composite is put on the surface of a first spacer 15, and then a second spacer 16 is put on the surface of the pre-composite. In step (c2), the pressure is about 2000 Pa. In step (c3), the composite is cooled at room temperature for about 5-6 minutes. In the cooling process, the agar 12 is slowly solidified and gradually reaches a fully-solidified state. After the agar attains a fully-solidified state, the first spacer 15 and the second spacer 16 can be removed. Thus, the first type membrane is obtained.

The first spacer 15 and the second spacer 16 can, opportunely, be chosen to have a predetermined surface structure. When a smooth membrane is selected/needed, for example, two flat substrates are selected to act as the first spacer 15 and the second spacer 16, respectively.

A thickness of the membrane obtained in the present embodiment can, advantageously, be controlled according to the need. For example, a fabric of fibers with an appropriate thickness can, beneficially, be chosen to make the membrane. Moreover, at least two layers of fabric can be overlapped and immersed into the slurry of agar to form a predetermined thickness of the membrane to be produced. As such, the formed membrane can have two or more fabric layers.

The second embodiment is similar to the first embodiment, except for the fiber material employed. In the second embodiment, a non-woven fiber material is selected as the fiber material to form the second type membrane. The production process is described in detail.

In step (a), the slurry of agar is prepared as per the first embodiment, or the prepared slurry of agar of the first embodiment is employed. In step (b), a non-woven fiber, such as paper pulp, is mixed with the slurry of agar and is then heated and agitated in the water bath at the temperature of about 80˜95° C. In step (c), after the paper pulp is uniformly mixed with the slurry of agar, the composite of the paper pulp and the agar is injected into a molding die (not shown) to form the membrane having a needed structure and size.

The structure and size of cavity in the molding die can, opportunely, be designed according to the structure and size of the formed membrane. The composite is, advantageously, rapidly injected into the molding die, so as to avoid the agar in the composite solidifying before formation of the desired composite is complete.

The membranes fabricated by the present embodiments can, advantageously, be used in the battery systems or super capacitors. To explain the function of the membrane, the use of the membrane in a lithium ion battery is provided as an example. The membrane, usually, is used to separate the anode and the cathode to avoid a short circuit happening therein. When the membrane is put into the electrolyte, due to the agar in the membrane having an excellent hygroscopic property, the agar in the membrane with the electrolyte dispersed in the membrane can, beneficially, form a gelatinous substance. On the one hand, the gelatinous substance existing in the membrane can make the membrane and the electrodes bond well together. On the other hand, the existence of the gelatinous substance in the membrane can, opportunely, promote a good saturation between the membrane and the electrolyte, which is beneficial to conduct ions in the process of charging and discharging. Therefore, this increases the ion penetrability of the membrane, thus reducing the internal resistance of the battery.

In addition, the membranes fabricated by the present embodiments have the following virtues.

Firstly, in the producing process, the used raw materials can be easily obtained with a low cost. For example, one of the raw materials used in the present embodiments is the agar, which is a natural polysaccharide polymer material. Therefore, the agar is easily obtained with a low cost.

Secondly, the membranes have a good mechanical strength and tensile strength, due to the presence of the fibrous material therein. In the assembly of parts, to avoid a potential membrane rupture, that could make the device susceptible to a short circuit, the membrane should have a certain minimum amount of mechanical strength. Moreover, in manufactured products, the membrane needs to have a certain degree of tensile strength and/or elasticity to accommodate an occasional minor deformation. The fiber in the present membranes opportunely acts as a skeleton/support structure. Thus, the present membranes have the good mechanical properties.

Thirdly, the present membranes have a good lyophilic property with liquid and a good ability of keeping/retaining liquid. Due to having these excellent properties, the agar can, advantageously, absorb an amount of water several times the weight of its own. The absorbed water and the agar in membrane together form a gelatinous substance. The formed gelatinous substance can increase the saturation between the membrane and the electrolyte and promote good bonding between the electrodes.

Finally, it is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

What is claimed is:

1. A membrane comprises a fiber material and an agar material distributed so as to surround the fiber material.

2. The membrane as claimed in claim 1, wherein the fiber material is comprised of a fabric of fibers.

3. The membrane as claimed in claim 2, wherein the fabric of fibers is comprised of at least one of natural fibers and artificial fibers.

4. The membrane as claimed in claim 3, wherein the fabric of fibers is selected from a group consisting of a gauze fabric, a non-woven fabric, a cotton fabric, and a glass fiber film.

5. The membrane as claimed in claim 1, wherein the agar is formed on the surface of the fibers and in the gaps between the fibers.

6. A membrane comprises an agar material and a fiber material dispersed in the agar.

7. The membrane as claimed in claim 6, wherein the fiber material is comprised of non-woven fibers.

8. The membrane as claimed in claim 7, wherein the non-woven fiber is comprised of at least one of paper pulp and wood pulp.

9. A method for making a membrane, comprising the steps of:
(a) mixing an agar material with water to form a slurry of agar;
(b) immerging a fiber material into the slurry of agar to form a pre-composite; and
(c) forming the pre-composite into a composite and solidifying the composite to obtain the membrane.

10. The method as claimed in claim 9, wherein step (a) further comprises the substeps of:
(a1) mixing the agar material with water at room temperature for about 8-10 hours to form an agar-water dispersion; and
(a2) heating the agar-water dispersion system in the water bath at a temperature of about 80˜95° C. for about 2-3 hours to form a slurry of agar.

11. The method as claimed in claim 10, wherein a weight percentage of the agar in the slurry of agar is in the approximate range from 1% to 2%.

12. The method as claimed in claim 9, wherein step (b) further comprises the substeps of:
(b1) providing at least one fabric of fibers and immersing each fabric of fibers into the slurry of agar to form the pre-composite; and
(b2) heating and agitating the pre-composite in the water bath at the temperature of about 80˜95° C.

13. The method as claimed in claim 12, wherein in step (b1), at least two fabrics of fibers are overlapped and immersed into the slurry of agar to form a multilayer membrane.

14. The method as claimed in claim 12, wherein in step (b2), the pre-composite is heated and agitated in the water bath for about 2-3 minutes.

15. The method as claimed in claim 9, wherein the fiber material is comprised of a fabric of fibers.

16. The method as claimed in claim 15, wherein step (c) further comprises the substeps of:
(c1) spreading out the pre-composite between two spacers;
(c2) compressing the pre-composite using the two spacers, under a certain pressure, to yield a composite; and
(c3) cooling and solidifying the composite, and removing the two spacers to obtain the membrane.

17. The method as claimed in claim 16, wherein in step (c2), the pressure is about 2000 Pa.

18. The method as claimed in claim 16, wherein in step (c3), the composite is cooled down at room temperature for about 5-6 minutes to yield the membrane.

19. The method as claimed in claim 9, wherein the fiber material is comprised of non-woven fibers.

20. The method as claimed in claim 19, wherein in step (c), the composite of the non-woven fibers and the agar is injected into a molding die to form the membrane.
